(19) United States
(12) Patent Application Publication
(10) Pub. No.: US 2020/0031379 A1
(43) Pub. Date: Jan. 30, 2020

(54) SHOPPING CART COVER

(71) Applicant: Ennovate Products LLC, Irvine, CA (US)

(72) Inventors: Johnny Chi-Pao Liao, Irvine, CA (US); Jiwon Yang, Costa Mesa, CA (US)

(21) Appl. No.: 16/525,529

(22) Filed: Jul. 29, 2019

Related U.S. Application Data
(60) Provisional application No. 62/711,443, filed on Jul. 27, 2018.

(51) Int. Cl. B62B 3/14

(52) U.S. Cl. CPC B62B 3/1448

(57) ABSTRACT

A shopping cart cover formed from a panel of material which is sized to substantially cover a child seat portion of a shopping cart and which includes leg flaps to protect the back of a child's legs.

### CROSS-REFERENCE TO RELATED APPLICATIONS

This application claims the benefit of priority under 35 U.S.C. § 119(e) from U.S. Patent Application No. 62/711,443, filed Jul. 27, 2018, the disclosure of which application is incorporated herein by reference in its entirety.

### BACKGROUND

A variety of stores, in particular grocery stores, provide carts to shoppers in order to allow them to transport goods within a store and/or to a vehicle in the store's parking lot. Shoppers with small children face the challenge of either transporting or managing their child while shopping, and for shoppers' convenience carts are often provided with a seat that a child can sit in. Typically, the seat is in the rear portion of a cart, adjacent to where a shopper pushes it. A child placed in such a seat normally faces the toward the shopper, with the child's legs placed through two openings in the rear face of the cart.

However, carts are used by many different shoppers, and therefore may retain a succession of children before being washed. Shopping cart surfaces handled by a sick child may be handled subsequently by another child, who is thereby at risk of contracting the illness of the sick child. The portion of the cart used to seat a child may also be used by other shoppers to retain eggs, meat, or other items that might carry bacteria or other disease vectors.

In order to shield a child in a shopping cart from such sources of potential illness, a variety of shopping cart covers have been proposed, for example in U.S. Pat. No. 3,578,380 to Jacobus, U.S. Pat. No. 8,857,905 to Pusateri, US Patent Publication No. 20060001225 to Gurley. There remains a need, however, for an improved shopping cart cover.

### SUMMARY

The present shopping cart cover comprises a panel of material which substantially covers a child seat portion of a shopping cart, adjacent to the basket of a shopping cart, and in addition provides leg flaps to protect the back of a child's legs. The present shopping cart cover is formed from a single layer of a single piece of material and is disposable for hygienic reasons. The shopping cart cover is generally formed from a panel of flexible, preferably water resistant material having an upper side, a lower side, a proximal side, a distal side, a right side, and a left side. The panel further includes a right side leg protector portion and a left side leg protector portion which form the leg flaps that protect the back of a child's legs. The right side leg protector portion is formed in a proximal portion of the panel, and has a perforation extending between the upper side and the lower side of the panel, the perforation extending distally from a proximal position to a distal position on a left lateral side, laterally from the distal position on the left lateral side to a distal position on a right lateral side, and proximally from the distal position on the right lateral side to a proximal position on the right lateral side, thereby forming a right side leg opening. The panel isn't perforated between the proximal position on the right lateral side and the proximal position on the left lateral side of the right side leg protector, thereby forming a right side leg protector panel in the form of a flap attached to the panel between the proximal position on the right lateral side and the proximal position on the left lateral side of the right side leg protector.

The panel also includes a left side leg protector portion formed in a proximal portion of the panel to the left of the right side leg protector portion. The left side leg protector portion likewise has a perforation extending between the upper side and the lower side of the panel, the perforation extending distally from a proximal position to a distal position on a left lateral side, laterally from the distal position on the left lateral side to a distal position on a right lateral side, and proximally from the distal position on the right lateral side to a proximal position on the right lateral side, thereby forming a left side leg opening. The panel isn't perforated between the proximal position on the right lateral side and the proximal position on the left lateral side of the right side leg protector, thereby forming a left side leg protector panel in the form of a flap attached to the panel between the proximal position on the right lateral side and the proximal position on the left lateral side of the left side leg protector.

In one embodiment, the perforations extend contiguously between the proximal position on the right lateral side and the proximal position on the left lateral side of each of the right side leg protector portion and the left side leg protector portion. However, in alternative embodiments, the perforated areas which define the flaps of the leg portions can be joined by joining portions prior to use and then separated by a user. For example, the leg opening can comprise a joining portion connecting the flap to the upper side, right side, and or left side of the leg opening. The joining portion is frangible to allow it to be torn.

The present panel can further include one or more seat belt openings formed in a proximal portion of the panel, where the seat belt openings each comprise a perforation having a right side and a left side. The panels described herein can be provided individually, or alternatively can be packaged with a group of other panels in a container.

### FIGURES

FIG. 1 is a top plan view of a first embodiment of the present shopping cart cover prior to being folded for use.

FIG. 2 is a bottom plan view of the embodiment of the present shopping cart cover of FIG. 1 prior to being folded for use.

FIG. 3 is a top plan view of a second embodiment of the present shopping cart cover prior to being folded for use. The bottom plan view of this embodiment is identical to the top plan view.

FIG. 4 is a left side perspective view of an embodiment of the present shopping cart cover, folded for use and showing the leg opening flaps separated from the remainder of the shopping cart cover.

FIG. 5 is a right side perspective view of the shopping cart cover of FIG. 4, folded for use and showing the leg opening flaps separated from the remainder of the shopping cart cover.

FIG. 6 is a perspective view of a carton for retaining and dispensing the present shopping cart cover.

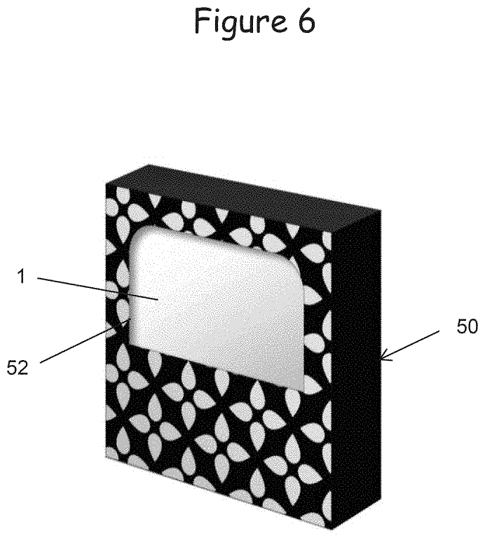

FIG. 7 is a right side perspective view of a shopping cart.

FIG. 8 is a right side perspective view of the child seat portion of the shopping cart of FIG. 7.

The reference numbers in the figures have the following meanings:

| Component | Subcomponent | Reference Number |
|---|---|---|
| cover | | 1 |
| panel | | 10 |
| | upper side | 11 |
| | lower side | 13 |
| | proximal side | 16 |
| | distal side | 18 |
| | right side | 12 |
| | left side | 14 |
| perforation | | 20 |
| joining portion | | 22 |
| cut line | | 24 |
| leg protector panel | | 30 |
| | proximal side | 36 |
| | distal side | 38 |
| | right side | 32 |
| | left side | 34 |
| right leg protector panel | | 31 |
| left leg protector panel | | 33 |
| right leg opening | | 41 |
| left opening | | 43 |
| | leg opening upper side | 45 |
| | leg opening right side | 46 |
| | leg opening left side | 47 |
| seat belt opening | | 40 |
| | right side | 42 |
| | left side | 44 |
| container | | 50 |
| | opening | 52 |
| shopping cart | | 100 |
| | proximal end | 106 |
| | distal end | 108 |
| | right side | 102 |
| | left side | 104 |
| | proximal wall | 116 |
| | basket portion | 120 |
| | handle | 130 |
| | seat belt | 135 |
| shopping cart child seat | | 150 |
| | proximal side | 156 |
| | distal side | 158 |
| | right side | 152 |
| | left side | 154 |
| | leg opening | 155 |
| | seat portion | 157 |

### DESCRIPTION

### Definitions

As used herein, the following terms and variations thereof have the meanings given below, unless a different meaning is clearly intended by the context in which such term is used.

“Arcuate” refers to a surface or shape which is curved, i.e. in the manner of a bow.

“Elongated” and “longitudinal” refer to a configuration or shape having a length which is longer than its width.

“Flap” refers to a component of an item which is hinged or attached only on one side or portion of the flap component.

“Frangible” refers to a material that is susceptible to being torn using an amount of force exerted by an average human adult.

“Lateral” refers to a side or a direction toward a side of a component.

“Outer” refers to a surface or direction which faces or extends away from the present cover or a component thereof, and may refer to a surface or direction which faces or extends away from the body of a user of the present cover (i.e., the caregiver) when the cover is in use. “Inner” may refer to the opposite direction or surface of the present cover. With respect to the fastener portions and fixation points described herein, the term “inner” generally refers to a position which is medial with respect to another fastener portion or fixation point, i.e. further from a lateral side or portion of the present cover.

“Panel” refers to a section or piece of flexible material, such as fabric, extending over or covering a predetermined area. Panels are generally relatively thin as compared to the extent of their length and width.

“Perforation” refers to one or more cuts or holes made in a panel, i.e. between an upper and lower surface of a panel.

“Upper” refers to a position or direction in or toward an upper portion of the body of a user of the present cover (i.e., the caregiver) when the cover is in use. “Lower” refers to an opposing position or direction, e.g. toward a lower portion of a user's body.

The terms “upper,” “lower,” “top”, “bottom, “outer,” “inner,” “right,” “left,” and similar terms will be used to designate areas and positions of portions of the present article, but it is to be understood that these terms are relative and are not absolute terms. “Right” and “left” will thus be used to designate opposing lateral sides of components of the present article of manufacture. “Upper” and “lower” will likewise be used to designate opposing faces or sides of components of the present article, and will be understood to be relative terms.

The term “comprise” and variations of the term, such as “comprising” and “comprises,” are not intended to exclude other additives, components, integers or steps. The terms “a,” “an,” and “the” and similar referents used herein are to be construed to cover both the singular and the plural unless their usage in context indicates otherwise. Ranges which are described as being “between” two values include the indicated values.

### Shopping Cart Seat Cover

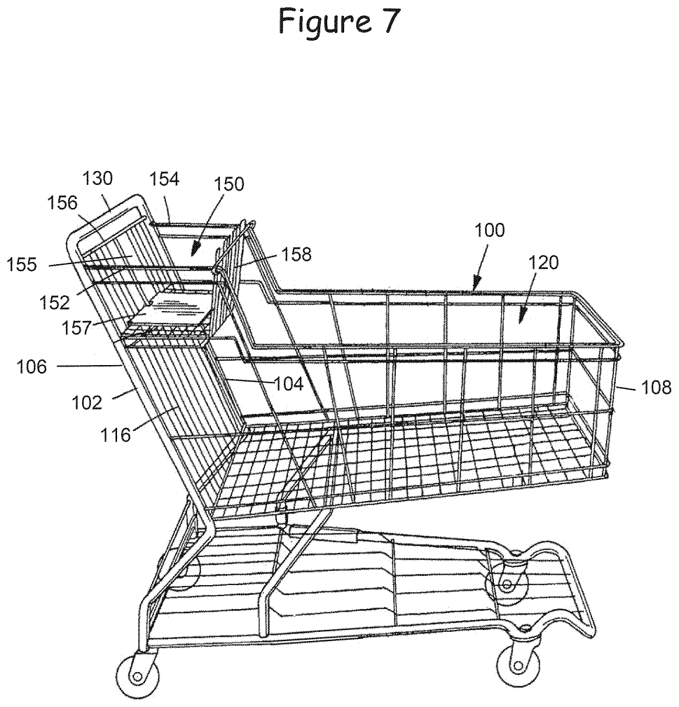

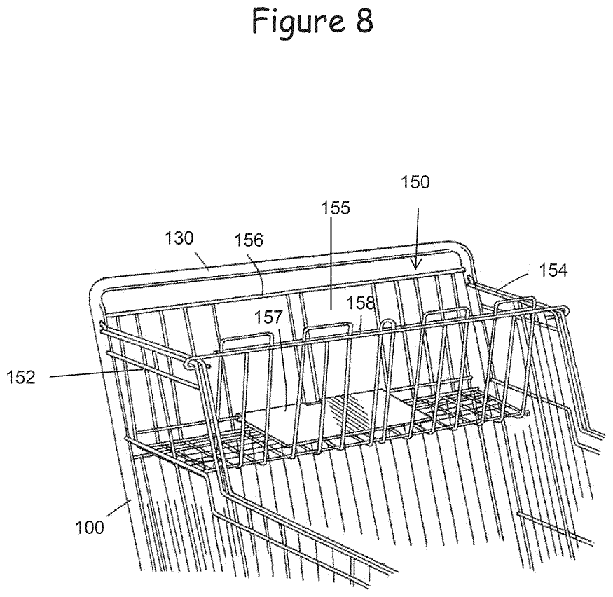

The present shopping cart seat cover 1 comprises a panel 10 for covering the child seat 150 of a shopping cart 100. As best seen in FIGS. 7 and 8, conventional shopping carts 100 generally include a basket portion 120 for retaining goods to be purchased and child seat portion 150. The shopping cart 100 has a proximal end 106, a distal end 108, a right side 102, and a left side 104. The child seat portion 150 is normally in the proximal end 106 of the shopping cart, nearest where an adult user pushes the shopping cart 100 with a handle 130. The child seat 150 generally comprises a proximal side 156, a distal side 158, a right side 152, a left side 154, and a seat portion 157, with leg openings 155 formed in the proximal side 156. The child seat 150 is generally integrally formed with the shopping cart 100, so that the proximal side 156 of the child seat is formed from a portion of a proximal wall 116 of the shopping cart 100. The right side 152 and left side 154 of the child seat 150 likewise form a portion of the right side 102 and left side 104 of the shopping cart 100. The structural portions of the shopping cart are typically formed from rigid metal bars or from molded plastic. When the shopping cart is formed from metal bars, a flat portion is often provided in the seat portion 157 of the child seat 150 for the comfort of the child.

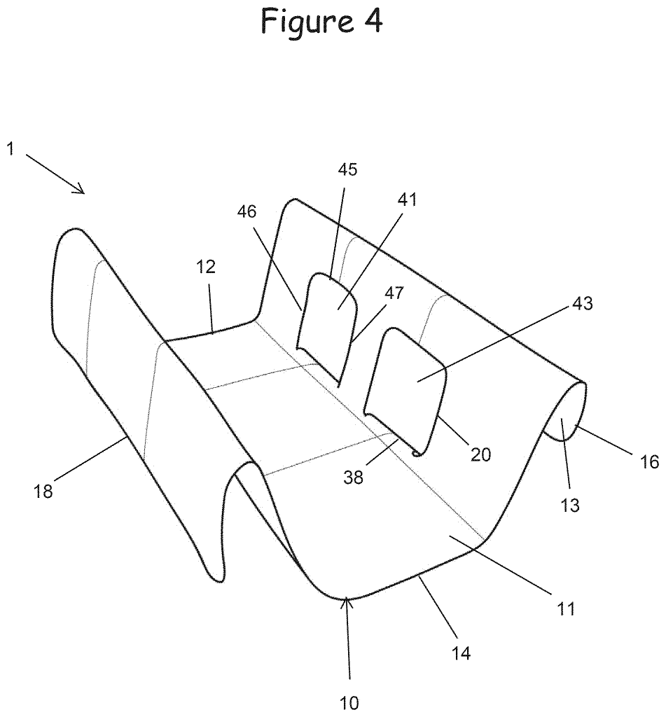

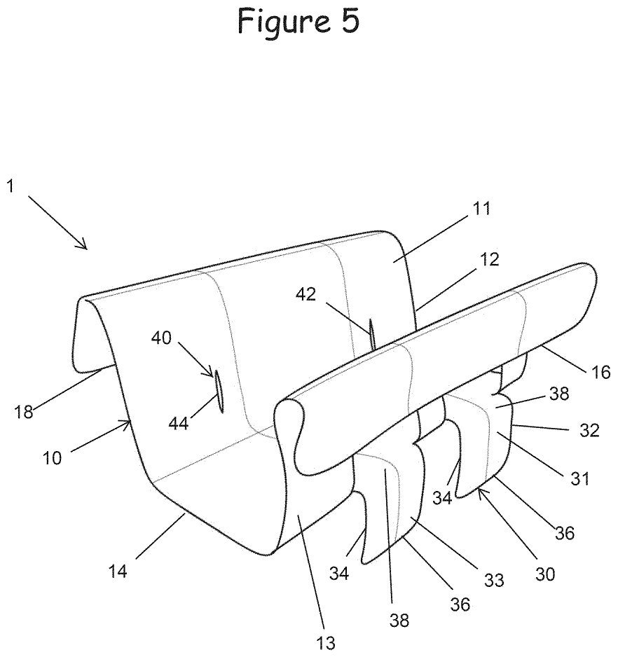

The panel 10 of the shopping cart seat cover 1 generally comprises an upper side 11, a lower side 13, a proximal side 16, a distal side 18, a right side 12, and a left side 14. In use, the lower side 13 is placed into contact with the upper surface of the seat portion 157 so that a child in the child seat 150 is placed in contact with the upper side 11 of the panel 10 and is thereby protected from direct contact with the shopping cart 100. The panel 10 is sized so that when it is placed in a child shopping cart seat 150, the distal side 18 extends beyond the upper end of the distal side 158 of the child seat 150 and the proximal side 16 extends beyond the upper end of the proximal side 156 of the child seat 150. The material used to form the present panels 10 is generally flexible and thereby conforms to the surfaces (156, 157, 158) forming the child seat 150 when placed therein. The panels of FIGS. 4 and 5 are shown in the conformation of the panel 10 in use, i.e. conforming to the shape of the shopping cart, with the proximal side 16 and distal side 18 folded in the manner that would occur when the panel is installed in a shopping cart child seat 150. Preferably, the proximal side 16 is installed in the space between the upper end of the proximal side 156 of the child seat 150 and the handle 130, as shown in FIGS. 9 and 10.

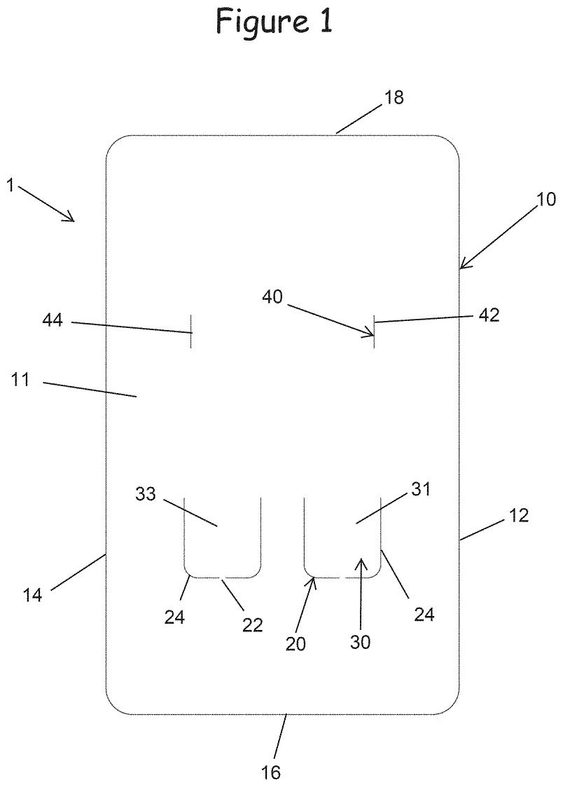

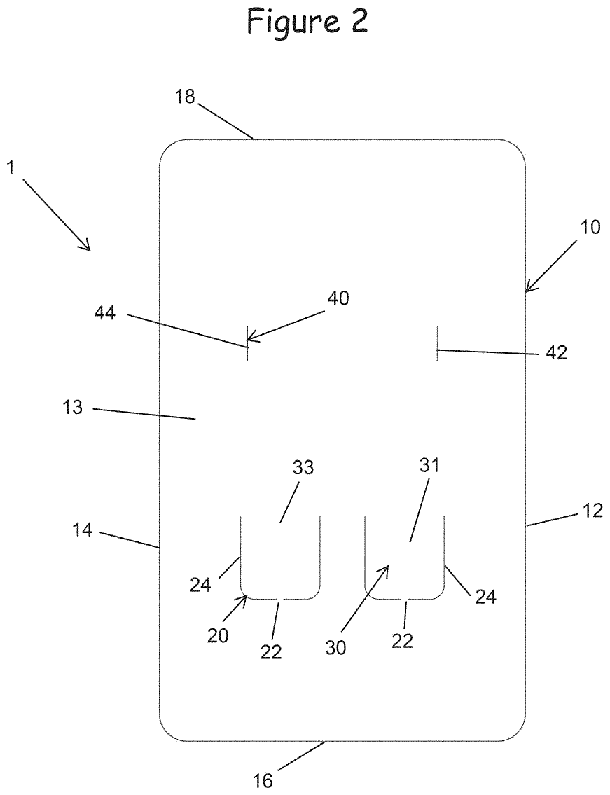

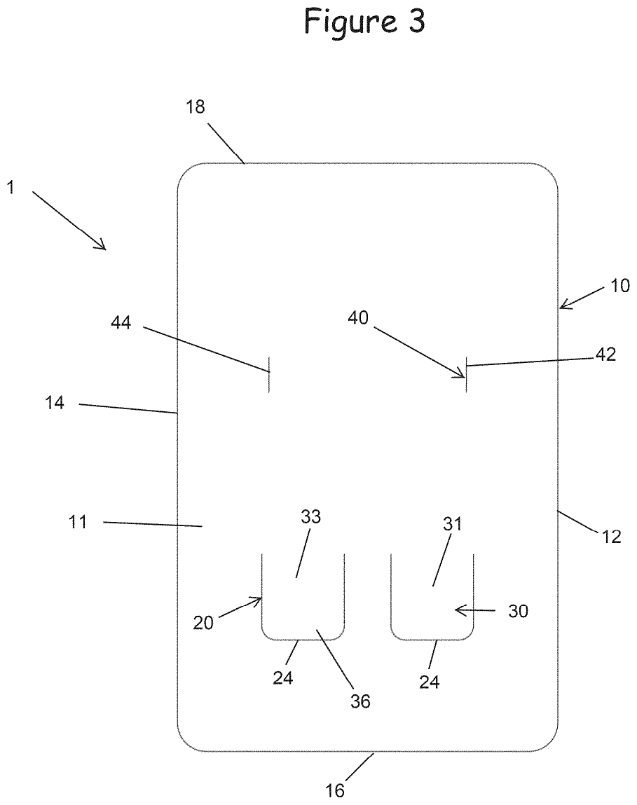

An important feature of the present shopping cart cover 10 is the inclusion of leg protector panels 30. These panels are formed from a pair of longitudinal areas of a proximal portion of the panel 30 which are separated from the panel to form elongated flaps, which can have generally arcuate distal ends with rounded edges. These longitudinal areas are fully or partially separated from the remainder of the panel on their right side, left side, and proximal end, but remain joined to the panel 10 on their distal side. This is accomplished by cutting the material of the panel 10 along cut lines 24. In the embodiment illustrated in FIG. 3, the panels 30 are completely separated (except on their distal ends 38) from the panel 10 along cut lines 24. In the embodiment illustrated in FIGS. 1 and 2, the proximal ends 36 of the panels 30 remain joined to the remainder of the panel 10 at joining portions 22, so that a user will need to tear or cut the joining portions 22 in order to separate the panels 30. Additional joining portions of material between perforated sections along the cut lines 24 can be included if desired, forming sets of perforations spaced at intervals along the cut lines 24.

As best seen in FIG. 5, the panels 30 each comprise a proximal side 36, a distal side 38, a right side 32, and a left side 34, with the proximal side 36, right side 32, and left side 34 detached from the panel 10 when in use, thereby forming a right leg protector panel 31 and a left leg protector panel 33. Separation of the right leg protector panel 31 and a left leg protector panel 33 from the panel 10 creates a right leg opening 41 and left opening 43, respectively, as best seen in FIG. 4. The right leg opening 41 and left opening 43 are aligned with corresponding leg openings 155 of the child seat 150, and the leg protector panels 30 extend through the leg openings 155 and bend downwardly, as shown in FIGS. 5 and 10, thereby forming a barrier between a child's legs and the outer surface of the proximal end 106 of the shopping cart 100.

In order to accommodate seat belts 135 which are often provided for shopping cart child seats 150, the panel 10 preferably includes two seat belt openings 40 formed by cuts or holes in a portion of the panel 10 located distally of the leg protector panels 30, namely a right side opening 42 and a left side opening 44. Seat belts 135 can be placed through the openings 40, as shown in FIGS. 9 and 10.

Although the present shopping cart seat cover 1 is intended for use with shopping carts 100, they can in addition be used with a restaurant child seat or booster seat to form a hygienic barrier between a child and the seat.

The panel 10 is preferably made from a continuous sheet of a thin, flexible material which is intended to be disposed of and/or recycled. Non-woven and non-porous materials are preferred in order to provide a waterproof or water resistant barrier between a shopping cart seat and a child seated therein for greater hygiene. For example, the material can be wax paper, i.e. a paper product impregnated or coated with a lipophilic material such as paraffin, wax, or other similar material. Sheets of plastic, such as polyolefin or polyester plastic, either alone or in combination with paper fibers, can be used, or other materials can also be used. Water resistance can be measured by appropriate standards, such as those promulgated by ASTM International. Preferably, the panels 10 have a water resistance equal to or better than wax paper.

In order to allow perforations in the panel 10, the panel is preferably made from a frangible material, i.e. one that can be torn using an amount of force exerted by an average human adult. The panel preferably has a tear resistance of between about 50 and 2000 mN, preferably between about 100 and 600 mN. Tear resistance can be measured according to TAPPI standards, such as TAPPI T 414, which uses an Elmendorf-type tear tester to measure the force required to tear plies of paper through a specified distance. Tear resistance of other materials can be measured by appropriate standards known to the skilled artisan, such as ASTM D 624 for elastomers.

The shopping cart seat cover 1 can be provided in individual sheets, but preferably is packaged as a group of panels 10. For example, a plurality of shopping cart seat covers 1 can be folded and packaged in a container 50 having an opening 52 from which individual panels 10 can be removed. Alternatively, multiple shopping cart seat covers 1 can be formed as a roll and dispensed by unrolling one end of the roll, in the manner a roll of plastic bags. In this embodiment, the distal side 18 of a first panel 10 is joined to the proximal side 16 of an adjoining, second panel 10 in a manner that allows the first panel to be removed from the second panel, such as by providing a partially perforated joining section between the two panels.

Although the present invention has been described in considerable detail with reference to certain preferred embodiments, other embodiments are possible. The steps disclosed for the present methods, for example, are not intended to be limiting nor are they intended to indicate that each step is necessarily essential to the method, but instead are exemplary steps only. Therefore, the scope of the appended claims should not be limited to the description of preferred embodiments contained in this disclosure.

Recitation of value ranges herein is merely intended to serve as a shorthand method for referring individually to each separate value falling within the range. Unless otherwise indicated herein, each individual value is incorporated into the specification as if it were individually recited herein. All references cited herein are incorporated by reference in their entirety.

What is claimed is:

1. A cover for a shopping cart formed from a panel of flexible material, the panel having an upper side, a lower side, a proximal side, a distal side, a right side, and a left side, the panel further comprising:
a right side leg protector portion formed in a proximal portion of the panel, the right side leg protector portion comprising a perforation extending between the upper side and the lower side of the panel, the perforation extending distally from a proximal position to a distal position on a left lateral side, laterally from the distal position on the left lateral side to a distal position on a right lateral side, and proximally from the distal position on the right lateral side to a proximal position on the right lateral side, thereby forming a right side leg opening, wherein the panel is not perforated between the proximal position on the right lateral side and the proximal position on the left lateral side of the right side leg protector, and wherein the right side leg protector portion forms a right side leg protector panel in the form of a flap attached to the panel between the proximal position on the right lateral side and the proximal position on the left lateral side of the right side leg protector, the right side leg protector panel having a proximal side, a distal side, a right side, and a left side; and
a left side leg protector portion formed in a proximal portion of the panel, the left side leg protector portion being located laterally to the left of the right side leg protector portion, the left side leg protector portion comprising a perforation extending between the upper side and the lower side of the panel, the perforation extending distally from a proximal position to a distal position on a left lateral side, laterally from the distal position on the left lateral side to a distal position on a right lateral side, and proximally from the distal position on the right lateral side to a proximal position on the right lateral side, thereby forming a left side leg opening, wherein the panel is not perforated between the proximal position on the right lateral side and the proximal position on the left lateral side of the left side leg protector, and wherein the left side leg protector portion forms a left side leg protector panel in the form of a flap attached to the panel between the proximal position on the right lateral side and the proximal position on the left lateral side of the left side leg protector, the left side leg protector panel having a proximal side, a distal side, a right side, and a left side.

2. The cover of claim 1, wherein the perforation extends contiguously between the proximal position on the right lateral side and the proximal position on the left lateral side of each of the right side leg protector portion and the left side leg protector portion.

3. The cover of claim 1, wherein the leg opening of each of the right side leg protector portion and the left side leg protector portion comprises an upper side and the perforation does not extend contiguously between the proximal position on the right lateral side and the proximal position on the left lateral side of the respective leg protector portion, wherein the leg opening further comprises a joining portion connecting the flap to the upper side of the leg opening, and wherein the joining portion is frangible.

4. The cover of claim 1, wherein the leg opening of each of the right side leg protector portion and the left side leg protector portion comprises a right side and the perforation does not extend contiguously between the proximal position on the right lateral side and the proximal position on the left lateral side of the respective leg protector portion, wherein the leg opening further comprises a joining portion connecting the flap to the right side of the leg opening, and wherein the joining portion is frangible.

5. The cover of claim 1, wherein the leg opening of each of the right side leg protector portion and the left side leg protector portion comprises a left side and the perforation does not extend contiguously between the proximal position on the right lateral side and the proximal position on the left lateral side of the leg protector portion, wherein the leg opening further comprises a joining portion connecting the flap to the left side of the leg opening, and wherein the joining portion is frangible.

6. The cover of claim 1, further comprising a seat belt opening formed in a proximal portion of the panel, the seat belt opening comprising a perforation having a right side and a left side.

7. The cover of claim 1, wherein the panel is formed from a water resistant material.

8. The cover of claim 1, wherein the panel packaged with a group of other panels in a container.
